(19) United States
(12) Patent Application Publication
(10) Pub. No.: US 2012/0198764 A1
(43) Pub. Date: Aug. 9, 2012

(54) METHOD FOR REDUCING PHYTOTOXICITY

(75) Inventors: Hiroshi Yoshii, Kusatsu-shi (JP); Tatsumi Nakamura, Tokyo (JP); Hiroshi Kikugawa, Osaka (JP); Tomoaki Kezuka, Nishi-ku (JP); Ryu Yamada, Kusatsu-shi (JP); Ema Mitsuno, Osaka-shi (JP)

(73) Assignee: Ishihara Sangyo Kaisha, Ltd., Osaka-shi, Osaka (JP)

(21) Appl. No.: 13/502,029

(22) PCT Filed: Oct. 13, 2010
(86) PCT No.: PCT/JP2010/067980

§ 371 Date: Apr. 13, 2012

(30) Foreign Application Priority Data
Oct. 14, 2009 (JP) 2009-236895

(51) Int. Cl. A01G 13/00

(52) U.S. Cl. 47/57.7

(57) ABSTRACT

To provide a method for reducing phytotoxicity to turfgrass due to flazasulfuron, which is not expensive but easily available and simple in the field of horticulture/agriculture.

Phytotoxicity to turfgrass due to flazasulfuron is reduced by using a pigment containing metal ions or a colorant comprising the pigment containing metal ions, particularly by using a phthalocyanine metal complex or a cyano-bridged metal complex.

### TECHNICAL FIELD

The present invention relates to a method for reducing phytotoxicity to turfgrass due to flazasulfuron, which comprises using a pigment containing metal ions or a colorant comprising the pigment containing metal ions.

### BACKGROUND ART

Heretofore, it is known to use flazasulfuron as an active ingredient for herbicides, for example, Patent Document 1. Flazasulfuron is an excellent compound which satisfies both an excellent safety to specific turfgrasses, particularly warm-season Japanese turfgrasses such as mascarenegrass or Japanese lawngrass and an effect to control undesired plants or inhibit their growth. However, the situation is complicated at golf courses, etc. where plural types of turfgrasses are planted in various arrangements. In such places, there are teeing grounds, fairways, roughs, woods, greens, etc., and in some cases, different kinds of turfgrasses may be planted around places where turfgrasses to which flazasulfuron shows safety are planted. If such places are treated with flazasulfuron, a spray liquid unintentionally flows out or scatters around the treated place, and phytotoxicity may result depending on types of turfgrasses or weather conditions.

Warm-season Japanese turfgrasses having a high safety to flazasulfuron such as mascarenegrass or Japanese lawngrass are planted on fairways of golf courses in the area of west of Kanto in Japan, however, American and European turfgrasses such as bentgrass, bluegrass or ryegrass which may suffer from phytotoxicity due to flazasulfuron depending on conditions are planted on greens, etc. in many cases. Further, immediately after warm-season Japanese turfgrasses such as mascarenegrass or Japanese lawngrass are treated with flazasulfuron, golf players may walk thereon in some cases. In such a case, flazasulfuron sticks on soles of shoes of golf players, and if the golf players walk on greens, etc. where American and European turfgrasses are planted, flazasulfuron sticks to American and European turfgrasses planted there, and phytotoxicity thereby results.

On the other hand, a pigment containing metal ions is used as a colorant in combination with a sticker or the like. Such a colorant has been used for turning discolored turfgrass into green in a low temperature winter season or treating turfgrass of which color is changed due to a disease, lesion, phytotoxicity or the like to camouflage damages. However, it has not been known to reduce phytotoxicity to turfgrass such as growth inhibition or necrosis due to a herbicide by using the pigment containing metal ions.

Patent Document 2 and 3 disclose a colorant composition having a growth-promoting effect, which contains a sticker and a specific blue pigment as a colorant component.

### PRIOR ART DOCUMENTS

### Patent Documents

Patent Document 1: U.S. Pat. No. 4,744,814

Patent Document 2: JP-A-10-234231

Patent Document 3: JP-A-11-228859

### DISCLOSURE OF INVENTION

### Technical Problem

Depending on conditions, flazasulfuron causes phytotoxicity to certain turfgrasses in some cases. In order to reduce such a phytotoxicity, various conventional phytotoxicity-reducing agents are used, however, such phytotoxicity-reducing agents are expensive, and there are various restrictions such that objects to be treated, a period for treatment and methods for treatment are restricted. Further, in a case where golf courses are treated with flazasulfuron, golf players with shoes wherein flazasulfuron sticks to those soles may walk on places such as greens where turfgrasses which suffer from phytotoxicity due to flazasulfuron is planted, and phytotoxicity may thereby result. It is an object of the present invention to provide a method for simply reducing phytotoxicity to turfgrass due to flazasulfuron by using one which is inexpensive and readily available in the field of horticulture/agriculture.

### Solution to Problem

As a result of studies to solve the above problem, the present inventors have found that phytotoxicity to turfgrass due to a herbicide containing flazasulfuron as an active ingredient can be reduced by using a pigment containing metal ions or a colorant comprising the pigment containing metal ions.

Since it is described in Patent Document 2 (paragraph [0003]) and Patent Document 3 (paragraph [0002]) that there is no physiological (raising) effect of a metal phthalocyanine type pigment on turfgrass, while the metal phthalocyanine type pigment has a remarkable effect to reduce phytotoxicity due to flazasulfuron in the present invention, the effect of the present invention is unexpected and cannot be inferred from such prior arts.

The present invention provides the following.
(1) A method for reducing phytotoxicity to turfgrass due to flazasulfuron, which comprises using a pigment containing metal ions or a colorant comprising the pigment containing metal ions.
(2) The method according to the above (1), wherein turfgrass is American and European turfgrasses.
(3) The method according to the above (1) or (2), wherein prior to treatment with flazasulfuron, turfgrass is treated with a pigment containing metal ions or a colorant comprising the pigment containing metal ions.
(4) The method according to the above (1) or (2), wherein after treatment with flazasulfuron, turfgrass is treated with a pigment containing metal ions or a colorant comprising the pigment containing metal ions.
(5) The method according to any one of the above (1) to (4), wherein the pigment containing metal ions is a phthalocyanine metal complex.
(6) The method according to any one of the above (1) to (4), wherein the pigment containing metal ions is a cyano-bridged metal complex.
(7) The method according to any one of the above (1) to (6), wherein the metal ions are copper ions.
(8) The method according to any one of the above (1) to (6), wherein the metal ions are iron ions.
(9) A method for reducing phytotoxicity to turfgrass due to flazasulfuron, which comprises using a colorant.

### Advantageous Effects of Invention

According to the present invention, by treating turfgrass with a pigment containing metal ions which is readily available in the field of agriculture and horticulture, phytotoxicity to turfgrass due to flazasulfuron can be reduced simply and at a low cost.

The method of the present invention is particularly effective to reduce phytotoxicity to American and European turfgrasses such as bentgrass, bluegrass, ryegrass, etc. which are likely to suffer from phytotoxicity due to a herbicide containing flazasulfuron as an active ingredient.

### DESCRIPTION OF EMBODIMENTS

Flazasulfuron (ISO common name: flazasulfuron) is the compound having the following chemical structure.

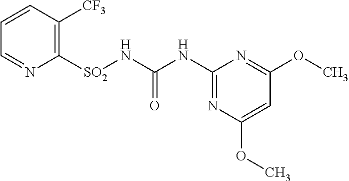

As the herbicides containing flazasulfuron as an active ingredient, for example, wettable powders or water dispersible granules such as SHIBAGEN wettable powder, SHIBAGEN DF or Katana (these are tradenames, manufactured by Ishihara Sangyo Kaisha, Ltd.) are known.

The pigment containing metal ions used in the present invention may, for example, be a phthalocyanine metal complex or a cyano-bridged metal complex.

The metal ions may, for example, be copper ions, iron ions or aluminum ions, and copper ions and iron ions are preferred.

The phthalocyanine metal complex may, for example, be a copper phthalocyanine such as Pigment Blue 15, Pigment Blue 15:3, Pigment Blue 76, Ingrain Blue 1 or Direct Blue 86; a chlorinated copper phthalocyanine such as Pigment Green 7: a chlorobrominated copper phthalocyanine such as Pigment Green 36; a chlorobrominated copper phthalocyanine such as Pigment Green 58; or aluminum phthalocyanine.

The cyano-bridged metal complex may, for example, be Prussian Blue.

The pigment containing metal ions is preferably the phthalocyanine metal complex, more preferably the copper phthalocyanine or the chlorinated copper phthalocyanine.

As the case requires, the pigment containing metal ions of the present invention may be used together with another pigment or a dye, or a binder or a dispersant. The pigment of the present invention is usually used in a state dispersed in an aqueous medium.

The binder is preferably one which can be subjected to film formation at normal temperature and has an appropriate hardness. The resin used as such a binder may, for example, be a synthetic resin emulsion which can be subjected to film formation at normal temperature such as an acrylic resin emulsion, an acrylate copolymer resin emulsion, a vinyl acetate emulsion, an ethylene vinyl acetate emulsion, a urethane resin emulsion or vinyl chloride resin emulsion, or a water soluble resin such as a polyvinyl alcohol, a water-soluble acrylic resin, a maleic resin or starch or a mixture thereof.

Further, as the dispersant, a surfactant such as an anionic surfactant, a cationic surfactant or a nonionic surfactant may be used.

In the present invention, a colorant comprising the pigment containing metal ions may be used. Such a colorant may contain various adjuvants which are used in this field, in addition to the pigment containing metal ions. As such adjuvants, for example, other pigments or other dyes, binders or dispersants may be mentioned. The colorant of the present invention is usually used in a state dispersed in an aqueous medium. Further, as the binder or the dispersant used here, the same one mentioned in the above pigment containing metal ions may be used.

As examples of commercial products of the colorant, the following products may be mentioned.

| Tradename | Manufacturers |
|---|---|
| Green Way, Green Way Sayaka | Otsuka Chemical Co., Ltd. |
| Clear Green L, Clear Green D | Ohkawaya Co., Ltd. |
| Exceloan K | Rikengreen Co., Ltd. |
| FULLGREEN S, FULLGREEN | Sugimura Chemical Industrial Co., |
| FR, FULLGREEN G20 | Ltd. |
| Dai-agricul Green | Dainichiseika Color & Chemicals |
| | Mfg. Co., Ltd. |
| TurfGreen BG, TurfGreen KG, | Nisso Green Co., Ltd. |
| TurfGreen SG, Turf Green FW | |

Further, TurfGreen BG is a colorant containing Pigment Green 7 which is the pigment containing metal ions.

| Tradename | Manufacturers |
|---|---|
| Match Play | Pioneer Manufacturing Co., Inc. |
| MTP TurfGreen | Missouri Turf Colorant |
| Lineman Pro Green | Becker Underwood |
| Green Lawnger | Becker Underwood |
| TURF-COTE | POULENGER USA, Inc. |
| Warm up | Loveland Products, Inc. |
| EnviroColor (registered | EnviroColor USA LLC |
| trademak) 4 EverGreen | |
| WINTERGREEN PLUS | Precision Laboratories Incorporated |
| REGREEN | Precision Laboratories Incorporated |
| REPLACE | Precision Laboratories Incorporated |
| Titan Green Turf | Burnett Athletics, Inc |
| LESCO Green | John Deere Landscapes |
| Turf in a Bottle | US Specialty Coatings, Inc. |

Flazasulfuron is formulated into for example the above water dispersible granules, diluted with water together with an adjuvant prior to application to turfgrass and then sprayed for foliar applications or soil applications. Further, flazasulfuron may be used together with another herbicide, an insecticide, a fungicide or a fertilizer for treatment of turfgrass. A sprayer used for treating turfgrass with a diluted spray liquid is not particularly restricted, and a riding type boom sprayer, a small power sprayer provided with a compressor or a compressed gas cylinder, a hand portable pump sprayer or a watering can may be mentioned. Such treatment is applied to warm-season Japanese turfgrasses such as mascarenegrass or Japanese lawngrass to control undesired plants or inhibit the growth of undesired plants. In such treatment, for example, from 50 to 600 g/ha (from 12.5 to 150 g a.i./ha as the flazasulfuron standard), preferably from 100 to 400 g a.i./ha (from 25 to 100 g/ha as the flazasulfuron standard) of SHIBAGEN DF (tradename) containing 25 wt % of flazasulfuron is usually diluted with water in an amount of from 100 to 5,000 L/ha, preferably from 150 to 3,000 L/ha.

Prior to the treatment, the pigment containing metal ions or the colorant comprising the pigment containing metal ions is diluted with water to from 5 to 5,000 times, preferably from 40 to 2,000 times. The diluted spray liquid is sprayed to turfgrass in an amount corresponding to from 50 to 500 mL/m² (from 500 to 5,000 L/ha), preferably from 100 to 250 mL/m² (from 1,000 to 2,500 L/ha). A sprayer to be used for the treatment to spray the diluted spray liquid to turfgrass is not particularly restricted, however, a riding type boom sprayer, a small power sprayer provided with a compressor or a compressed gas cylinder, a hand portable pump sprayer or a watering can may be mentioned.

Further, in the present invention specification, L represents liter, and ha represents hectare.

Before or after the treatment with flazasulfuron or at the same time of the treatment with flazasulfuron, the pigment containing metal ions or the colorant comprising the pigment containing metal ions is applied around turfgrass which is likely to suffer from flazasulfuron, however, the pigment containing metal ions or the colorant comprising the pigment containing metal ions is preferably preliminary applied to turfgrass which is likely to suffer from phytotoxicity before flazasulfuron is applied around turfgrass which is likely suffer from phytotoxicity due to flazasulfuron. More preferably within 10 days prior to the treatment with flazasulfuron, further preferably within 5 days, the pigment containing metal ions or the colorant comprising the pigment containing metal ions is preferably applied.

Further, ever after flazasulfuron is applied around turfgrass which is likely suffer from phytotoxicity due to flazasulfuron, phytotoxicity to turfgrass can be reduced by the treatment with the pigment containing metal ions or the colorant comprising the pigment containing metal ions within 15 days after the treatment with flazasulfuron, preferably within 10 days.

For example, as a place which is treated with the pigment containing metal ions or the colorant comprising the pigment containing metal ions, for example in a case of golf courses, the entire surfaces of greens which are concerned with phytotoxicity may be treated, a part of them may be treated, or depending on situations, places to be treated may be appropriately selected.

At the time of the treatment to spray the pigment containing metal ions or the colorant comprising the pigment containing metal ions to turfgrass, an anti-freezing agent, a pH regulator, antiseptics or fertilizers may be added to a spray liquid.

In the present invention, turfgrass of which phytotoxicity due to flazasulfuron can be reduced may, for example, be American and European turfgrasses such as bentgrass, bluegrass or ryegrass.

The effect to stimulate growth of plants requires usually from about 1 to 2 months for the confirmation of the effect, while the effect to reduce phytotoxicity of the present invention turns out in a short period.

Specifically, in a case where the pigment containing metal ions or the colorant comprising the pigment containing metal ions is applied prior to the treatment with flazasulfuron or at the same time of the treatment with flazasulfuron, the effect can usually be obtained from about 7 to 14 days after the treatment with flazasulfuron.

In a case where the pigment containing metal ions or the colorant comprising the pigment containing metal ions is applied after the treatment with flazasulfuron, the effect can be obtained usually from about 7 to 14 days after the treatment with the pigment containing metal ions or the colorant comprising the pigment containing metal ions.

Next, as preferred embodiments of the present invention, some examples will be mentioned. However, the present invention cannot be restricted to such examples.
(1) A method for reducing phytotoxicity to turfgrass due to flazasulfuron by using a pigment containing metal ions.
(2) The method according to the above (1), wherein turfgrass is American and European turfgrasses.
(3) The method according to the above (2), wherein American and European turfgrasses is bentgrass.
(4) The method according to any one of the above (1) to (3), wherein prior to the treatment with flazasulfuron, turfgrass is treated with the pigment containing metal ions.
(5) The method according to any one of the above (1) to (3), wherein after the treatment with flazasulfuron, turfgrass is treated with a pigment containing metal ions.
(6) The method according to any one of the above (1) to (5), wherein the pigment containing metal ions is a phthalocyanine metal complex.
(7) The method according to any one of the above (1) to (5), wherein the pigment containing metal ions is a cyano-bridged metal complex.
(8) The method according to any one of the above (1) to (7), wherein the metal ions are copper ions.
(9) The method according to any one of the above (1) to (7), wherein the metal ions are iron ions.
(10) A method for reducing phytotoxicity to turfgrass due to flazasulfuron by using a colorant.
(11) The method according to the above (10), wherein the colorant comprises the pigment containing metal ions.
(12) The method according to the above (10) or (11), wherein the colorant is TurfGreen, Green Way, Green Way Sayaka, Clear Green L or FULLGREEN S.

### EXAMPLES

Now, the present invention will be described in further detail with reference to Examples (Test Examples). However, it should be understood that the present invention is by no means restricted thereto.

### Test Example 1

1/300,000 ha pots were prepared, as the present invention area, comparative area and non-treated area, soil was put into them, and bentgrass (breed: pencross) in sod state (state of mat) was planted thereon. With respect to the bentgrass in the present invention area, after the bentgrass root-took on soil, a spray liquid was prepared by diluting a colorant for turfgrass (tradename: TurfGreen BG (containing chlorinated copper phthalocyanine), manufactured by Nisso Green Co., Ltd.) with water to 50 times, and the bentgrass was subjected to foliar treatment with the spray liquid in an amount of about 2,000 L/ha by a small spray gun. After 7 days, a spray liquid was prepared by diluting a predetermined amount (corresponding to flazasulfuron: 3.125 g a.i./ha) of water dispersible granules (tradename: SHIBAGEN DF, manufactured by Ishihara Sangyo Kaisha, Ltd.) containing flazasulfuron as an active ingredient of herbicides with water containing 0.02 wt % of an agricultural adjuvant (tradename: Kusa-rino, manufactured by Nihon Nohyaku Co., Ltd.), and the bentgrass in the present invention area and comparative area were subjected to foliar treatment with the spray liquid in an amount of about 2,000 L/ha by a small spray gun.

On 13th day after the treatment with flazasulfuron, the state of growth of bentgrass was visually observed and evaluated in accordance with growth inhibition rate (%)=0 (equivalent to the non-treated area) to 100 (complete kill), and thereby the results shown in Table 1 were obtained. Further, the test was carried out in duplicate.

TABLE 1

| | State of growth of bentgrass | |
|---|---|---|
| | On 13th day after the | |
| | treatment with flazasulfuron | |
| | Growth inhibition rate (%) | Note |
| Present | 39 | Treated with flazasulfuron on |
| invention | | 7th day after the treatment with |
| area | | Turf Green BG |
| Com- | 50 | Not treated with TurfGreen BG, |
| parative | | only treated with flazasulfuron |
| area | | |

It is evident from Table 1 that with respect to the bentgrass which was preliminarily treated with TurfGreen BG prior to the treatment with flazasulfuron in the present invention area, the growth inhibition rate was low, and thereby the phytotoxicity due to flazasulfuron was reduced by TurfGreen BG, as compared with comparative area which was not treated with TurfGreen BG.

### Test Example 2

1/1,000,000 ha pots were prepared, as the present invention area, comparative area and non-treated area, soil was put into them, and bentgrass (breed: pencross) in sod state was planted thereon. With respect to the bentgrass in the present invention area and comparative area, after the bentgrass root-took on soil, a spray liquid was prepared by diluting a predetermined amount (corresponding to flazasulfuron: 5 g a.i./ha) of SHIBAGEN DF (tradename, the same as in Test Example 1) with water containing 0.02 wt % of Kusa-rino (tradename, the same as in Test Example 1), and the bentgrass in the present invention area and comparative area were subjected to foliar treatment with the spray liquid in an amount of about 2,000 L/ha by a small spray gun. After 1 day, a spray liquid was prepared by diluting TurfGreen BG (tradename, the same as in Test Example 1) with water to 50 times, and the bentgrass in the present invention area was subjected to foliar treatment with the spray liquid in an amount of about 2,000 L/ha by a small spray gun.

On 7th day after the treatment with TurfGreen BG, the state of growth of bentgrass was evaluated in the same manner as in Test Example 1, and thereby the results shown in Table 2 were obtained. Further, the test was carried out in duplicate.

TABLE 5

| | State of growth of bentgrass | |
|---|---|---|
| | On 7th day after the | |
| | treatment with TurfGreen BG | |
| | Growth inhibition rate (%) | Note |
| Present | 35 | Treated with TurfGreen BG |
| invention | | on 1st day after the treatment |
| area | | with flazasulfuron |
| Com- | 48 | Only treated with |
| parative | | flazasulfuron, not treated |
| area | | with TurfGreen BG |

It is evident from Table 2 that with respect to the bentgrass which was treated with TurfGreen BG after the treatment with flazasulfuron in the present invention area, the growth inhibition rate was low, and thereby the phytotoxicity due to flazasulfuron was reduced by TurfGreen BG, as compared with comparative area which was not treated with TurfGreen BG.

### Test Example 3

Among bentgrass (breed: pencross) planted in sod state on ground in 0.5 m² (5.0×10⁻⁵ ha, 1 m×0.5 m) in the present invention area A, the present invention area B, comparative area and non-treated area, the bentgrass in the present invention area A, the present invention area B and comparative area were subjected to foliar treatment with a spray liquid prepared by diluting a predetermined amount (corresponding to flazasulfuron: 6.25 g a.i./ha) of SHIBAGEN DF (tradename, the same as in Test Example 1) with water containing 0.02 wt % of Kusa-rino (tradename, the same as in Test Example 1) in an amount of about 2,000 L/ha by a hand portable pump sprayer.

Further, a spray liquid was prepared by diluting TurfGreen BG (tradename, the same as in Test Example 1) with water to 50 times, the bentgrass in the present invention area A was subjected to foliar treatment with the spray liquid in an amount of about 2,000 L/ha by a hand portable pump sprayer on 1 day before the treatment with flazasulfuron, and the bentgrass in the present invention area B was subjected to foliar treatment with the spray liquid in an amount of about 2,000 L/ha by a hand portable pump sprayer on 3 days before the treatment with flazasulfuron.

On 14th day after the treatment with flazasulfuron, the state of growth of the bentgrass was evaluated in the same manner as in Test Example 1, and thereby the results shown in Table 3 were obtained. Further, the test was carried out in duplicate.

TABLE 3

| | State of growth of bentgrass | |
|---|---|---|
| | On 14th day after the | |
| | treatment with flazasulfuron | |
| | Growth inhibition rate (%) | Note |
| Present | 15 | Treated with TurfGreen BG on 1 |
| invention | | day before the treatment with |
| area A | | flazasulfuron |
| Present | 8 | Treated with TurfGreen BG on 3 |
| invention | | days before the treatment with |
| area B | | flazasulfuron |
| Com- | 40 | Only treatment with |
| parative | | flazasulfuron, not treated |
| area | | with TurfGreen BG |

It is evident from Table 3 that with respect to the bentgrass which was preliminarily treated with TurfGreen BG prior to the treatment with flazasulfuron in the present invention areas A and B, the growth inhibition rate was low, and thereby the phytotoxicity due to flazasulfuron was reduced by TurfGreen BG, as compared with comparative area which was not treated with TurfGreen BG.

### Test Example 4

Among bentgrass (breed: pencross) planted on ground in sod state in 0.5 m² (5.0×10⁻⁵ ha, 1 m×0.5 m) of the present invention area, comparative area and non-treated area, the bentgrasses in the present invention area and comparative area were subjected to foliar treatment with a spray liquid prepared by diluting a predetermined amount (corresponding to flazasulfuron: 6.25 g a.i./ha) of SHIBAGEN DF (tradename, the same as in Test Example 1) with water containing 0.02 wt % of Kusa-rino (tradename, the same as in Test Example 1) in an amount of about 2,000 L/ha by a hand portable pump sprayer. On 7th day after the treatment, a spray liquid was prepared by diluting TurfGreen BG (tradename, the same as in Test Example 1) with water to 50 times, and only the bentgrass in the present invention area was subjected to foliar treatment with the spray liquid in an amount of about 2,000 L/ha by a hand portable pump sprayer.

Prior to the treatment with TurfGreen BG or on 7th day after the treatment with TurfGreen BG, the state of growth of bentgrass was evaluated in the same manner as in Test Example 1, and thereby the results shown in Table 4 were obtained. Further, the test was carried out in duplicate.

TABLE 4

| | State of growth of bentgrass | |
|---|---|---|
| | On 7th day after the treatment | |
| | with Turf Green BG | |
| | Growth inhibition rate (%) | Note |
| Present | 10 | On 7th day after the |
| invention | | treatment with flazasulfuron, |
| area | | treated with TurfGreen BG |
| Com- | 30 | Only treated with |
| parative | | flazasulfuron, not treated |
| area | | with TurfGreen BG |

It is evident from Table 4 that with respect to the bentgrass which was treated with TurfGreen BG after the treatment with flazasulfuron in the present invention areas, the growth inhibition rate was low, and thereby the phytotoxicity due to flazasulfuron was reduced by TurfGreen BG, as compared with comparative area which was not treated with TurfGreen BG.

### Test Example 5

1/1,000,000 ha pots were prepared, as the present invention area, comparative area and non-treated area, soil was put into them, and bentgrass (breed: pencross) in sod state was planted thereon. After the bentgrass root-took on soil, a spray liquid was prepared by diluting a colorant for turfgrass (tradename: Green Way (pigment containing metal ions), manufactured by Otsuka Chemical Co., Ltd.), (tradename: Green Way Sayaka (pigment containing metal ions), manufactured by Otsuka Chemical Co., Ltd.) or (tradename: Clear Green L (copper phthalocyanine), manufactured by Ohkawaya Co., Ltd.) with water to 50 times, and the bentgrass in the present invention area was subjected to foliar treatment with the spray liquid in an amount of about 2,000 L/ha by a small spray gun. After 1 day, a spray liquid was prepared by diluting a predetermined amount (corresponding to flazasulfuron: 5 g a.i./ha) of SHIBAGEN DF (tradename, the same as in Test Example 1) with water containing 0.02 wt % of Kusa-rino (tradename, the same as in Test Example 1), and the bentgrass in the present invention area and comparative area were subjected to foliar treatment with the spray liquid in an amount of about 2,000 L/ha by a small spray gun.

On 7th day after the treatment with flazasulfuron, the state of growth of bentgrass was evaluated in the same manner as in Test Example 1, and thereby the results shown in Table 5 were obtained. Further, the test was carried out in triplicate.

TABLE 5

| | State of growth of bentgrass | |
|---|---|---|
| | On 7th day after the treatment | |
| | with flazasulfuron | |
| | Growth inhibition rate (%) | Note |
| Present | 37 | On 1st day after the |
| invention | | treatment with Green Way, |
| area | | treated with flazasulfuron |
| Present | 35 | On 1st day after the treatment |
| invention | | with Green Way Sayaka, |
| area | | treated with flazasulfuron |
| Present | 37 | On 1st day after the treatment |
| invention | | with Clear Green L, treated |
| area | | with flazasulfuron |
| Com- | 53 | Not treated with a colorant, |
| parative | | only treated with flazasulfuron |
| area | | |

It is evident from Table 5 that with respect to the bentgrass which was preliminarily treated with Green Way, Green Way Sayaka or Clear Green L prior to the treatment with flazasulfuron in the present invention areas, the growth inhibition rate was low, and thereby the phytotoxicity due to flazasulfuron was reduced by Green Way, Green Way Sayaka and Clear Green L, as compared with comparative area which was not treated with the colorant.

### Test Example 6

Among bentgrass (breed: pencross) planted on ground in sod state in 0.5 m² (5.0×10⁻⁵ ha, 1 m×0.5 m) of the present invention area A, the present invention area B, comparative area and non-treated area, the bentgrass in the present invention area A, the present invention area B and comparative area were subjected to foliar treatment with a spray liquid prepared by diluting a predetermined amount (corresponding to flazasulfuron: 6.25 g a.i./ha) of SHIBAGEN DF (tradename, the same as in Test Example 1) with water containing 0.02 wt % of Kusa-rino (tradename, the same as in Test Example 1) in an amount of about 2,000 L/ha by a small spray gun.

Further, a spray liquid was prepared by diluting FULLGREEN S (tradename, (copper phthalocyanine), manufactured by Sugimura Chemical Industrial Co., Ltd.) with water to 50 times, the bentgrass in the present invention area A was subjected to foliar treatment with the spray liquid in an amount of about 2,000 L/ha by a hand portable pump sprayer on 1 day before the treatment with flazasulfuron, and the bentgrass in the present invention area B was subjected to foliar treatment with the spray liquid in an amount of about 2,000 L/ha by a hand portable pump sprayer on 1 day after the treatment with flazasulfuron.

On 7th day after the treatment with flazasulfuron, the state of growth of bentgrass was evaluated in the same manner as in Test Example 1, and thereby the results shown in Table 6 were obtained. Further, the test was carried out in duplicate.

TABLE 6

| | State of growth of bentgrass | |
|---|---|---|
| | On 7th day after the treatment | |
| | with flazasulfuron | |
| | Growth inhibition rate (%) | Note |
| Present | 13 | On 1st day after the treatment |
| invention | | with FULLGREEN S, treated |
| area A | | with flazasulfuron |
| Present | 18 | On 1st day after the treatment |
| invention | | with flazasulfuron, treated |
| area B | | with FULLGREEN S |
| Com- | 31 | Not treated with a colorant, |
| parative | | only treated with flazasulfuron |
| area | | |

It is evident from Table 6 that with respect to the bentgrass which was treated with FULLGREEN S prior to or after the treatment with flazasulfuron in the present invention areas A and B, the growth inhibition rate was low, and thereby the phytotoxicity due to flazasulfuron was reduced by FULLGREEN S, as compared with comparative area which was not treated with FULLGREEN S.

### Test Example 7

1/1,000,000 ha pots were prepared, as the present invention area, comparative area and non-treated area, soil was put into them, and bentgrass (breed: pencross) in sod state was planted thereon. After the bentgrass root-took on soil, a spray liquid was prepared by diluting copper phthalocyanine or Prussian Blue with water to 1,000 times or 500 times, and the bentgrass in the present invention area was subjected to foliar treatment with the spray liquid in an amount of about 1,000 L/ha by a small spray gun. After 1 day, a spray liquid was prepared by diluting a predetermined amount (corresponding to flazasulfuron: 5 g a.i./ha) of SHIBAGEN DF (tradename, the same as in Test Example 1) with water containing 0.02 wt % of Kusa-rino (tradename, the same as in Test Example 1), and the bentgrass in the present invention area and comparative area were subjected to foliar treatment with the spray liquid in an amount of about 2,000 L/ha by a small spray gun.

On 8th day after the treatment with flazasulfuron, the state of growth of bentgrass was evaluated in the same manner as in Test Example 1, and thereby the results shown in Table7 were obtained. Further, the test was carried out in duplicate.

TABLE 7

| | State of growth of bentgrass | |
|---|---|---|
| | On 8th day after the treatment | |
| | with flazasulfuron | |
| | Growth inhibition rate (%) | Note |
| Present | 40 | On 1st day after the treatment |
| invention | | with copper phthalocyanine, |
| area | | treated with flazasulfuron |
| Present | 30 | On 1st day after the treatment |
| invention | | with Prussian Blue, treated |
| area | | with flazasulfuron |
| Com- | 55 | Not treated with a pigment, |
| parative | | only treated with flazasulfuron |
| area | | |

It is evident from Table 7 that with respect to the bentgrass which was preliminarily treated with copper phthalocyanine or Prussian Blue prior to the treatment with flazasulfuron in the present invention area, the growth inhibition rate was low, and thereby the phytotoxicity due to flazasulfuron was reduced by copper phthalocyanine or Prussian Blue, as compared with comparative area which was not treated with copper phthalocyanine or Prussian Blue.

### Test Example 8

1/1,000,000 ha pots were prepared, as the present invention area, comparative area and non-treated area, soil was put into them, and bentgrass (breed: pencross) in sod state was planted thereon. After the bentgrass root-took on soil, a spray liquid was prepared by diluting a predetermined amount (corresponding to flazasulfuron: 5 g a.i./ha) of SHIBAGEN DF (tradename, the same as in Test Example 1) with water containing 0.02 wt % of Kusa-rino (tradename, the same as in Test Example 1), and the bentgrass in the present invention area and comparative area were subjected to foliar treatment with the spray liquid in an amount of about 2,000 L/ha by a small spray gun. After 5 days, a spray liquid was prepared by diluting Prussian Blue with water to 500 times, and the bentgrass in the present invention area was subjected to foliar treatment with the spray liquid in an amount of about 1,000 L/ha by a small spray gun.

On 7th day after the treatment with Prussian Blue, the state of growth of bentgrass was evaluated in the same manner as in Test Example 1, and thereby the results shown in Table 8 were obtained. Further, the test was carried out in duplicate.

TABLE 8

| | State of growth of bentgrass | |
|---|---|---|
| | On 7th day after the treatment | |
| | with Prussian Blue | |
| | Growth inhibition rate (%) | Note |
| Present | 48 | On 5th day after the |
| invention | | treatment with flazasulfuron, |
| area | | treated with Prussian Blue |
| Com- | 54 | Only treated with |
| parative | | flazasulfuron, not treated |
| area | | with Prussian Blue |

It is evident from Table 8 that with respect to the bentgrass which was treated with Prussian Blue after the treatment with flazasulfuron in the present invention area, the growth inhibition rate was low, and thereby the phytotoxicity due to flazasulfuron was reduced by Prussian Blue, as compared with comparative area which was not treated with Prussian Blue.

### Test Example 9

1/1,000,000 ha pots were prepared, as the present invention area, comparative area and non-treated area, soil was put into them, and bentgrass (breed: pencross) in sod state was planted thereon. After the bentgrass root-took on soil, a spray liquid was prepared by diluting Pigment Green 7 with water to 125 times, and the bentgrass in the present invention area was subjected to foliar treatment with the spray liquid in an amount of about 1,000 L/ha by a small spray gun. After 1 day, a spray liquid was prepared by diluting a predetermined amount (corresponding to flazasulfuron: 10 g a.i./ha) of SHIBAGEN DF (tradename, the same as in Test Example 1) with water containing 0.02 wt % of Kusa-rino (tradename, the same as in Test Example 1), and the bentgrass in the present invention area and comparative area were subjected to foliar treatment with the spray liquid in an amount of about 2,000 L/ha by a small spray gun.

On 7th day after the treatment with flazasulfuron, the state of growth of bentgrass was evaluated in the same manner as in Test Example 1, and thereby the results shown in Table 9 were obtained. Further, the test was carried out in triplicate.

TABLE 9

| | State of growth of bentgrass | |
|---|---|---|
| | On 7th day after the treatment | |
| | with flazasulfuron | |
| | Growth inhibition rate (%) | Note |
| Present | 50 | On 1 day after the treatment |
| invention | | with Pigment Green 7, |
| area | | treated with flazasulfuron. |
| Com- | 56 | Not treated with Pigment |
| parative | | Green 7, only treated |
| area | | with flazasulfuron |

It is evident from Table 9 that with respect to the bentgrass which was preliminarily treated with Pigment Green 7 prior to the treatment with flazasulfuron in the present invention area, the growth inhibition rate was low, and thereby the phytotoxicity due to flazasulfuron was reduced by Pigment Green 7, as compared with comparative area which was not treated with Pigment Green 7.

### INDUSTRIAL APPLICABILITY

By simply using a pigment containing metal ions or a colorant comprising the pigment containing metal ions which is easily available in the field of horticulture/agriculture, phytotoxicity to turfgrass due to flazasulfuron can be simply reduced at low costs.

The entire disclosure of Japanese Patent Application No. 2009-236895 filed on Oct. 14, 2009 including specification, claims and summary is incorporated herein by reference in its entirety.

1. A method for reducing phytotoxicity to turfgrass due to flazasulfuron, the method comprising applying a pigment comprising a metal ion, or applying a colorant comprising the pigment, to a turfgrass.

2. The method of claim 1, wherein the turfgrass is American turfgrass, European turfgrass, or a mixture thereof.

3. The method of claim 1, wherein the applying of the pigment, or the applying of the colorant, occurs prior to treatment with flazasulfuron.

4. The method of claim 1, wherein the applying of the pigment, or the applying of the colorant, occurs after treatment with flazasulfuron.

5. The method of claim 1, wherein the pigment comprises a phthalocyanine metal complex.

6. The method of claim 1, wherein the pigment comprises a cyano-bridged metal complex.

7. The method of claim 1, wherein the metal ion is a copper ion.

8. The method of claim 1, wherein the metal ion is an iron ion.

9. The method of claim 1, comprising applying the colorant.

10. The method of claim 1, comprising applying the pigment.

11. The method of claim 2, wherein the turfgrass is American turfgrass and European turfgrass.

12. The method of claim 2, wherein the applying of the pigment, or the applying of the colorant, occurs prior to treatment with flazasulfuron.

13. The method of claim 2, wherein the applying of the pigment, or the applying of the colorant, occurs after treatment with flazasulfuron.
